(19) United States
(12) Patent Application Publication
(10) Pub. No.: US 2011/0226597 A1
(43) Pub. Date: Sep. 22, 2011

(54) Ultra-Thin Dynamically Self-Stabilizing Elastic Keyswitch

(76) Inventor: Shakoor Siddeeq, (US)

(21) Appl. No.: 13/050,939

(22) Filed: Mar. 18, 2011

Related U.S. Application Data
(60) Provisional application No. 61/340,522, filed on Mar. 18, 2010.

(51) Int. Cl. H01H 13/02

(52) U.S. Cl. 200/329

(57) ABSTRACT

A keyboard containing a number of keys that contain dynamically stabilizing self-balancing keyswitches that are expandable and compressible. Each key includes a compressible-expandable elastic keyswitch, a rigid keyboard base, a mechanical actuator switch, and a printed circuit board. Each elastic keyswitch includes a rigid keytop, one or more thin elastic membranes, and a compressible-expandable spherical surface. The compressible-expandable spherical surface allows the keyboard to dissipate key wobble and also compress to a very thin flat surface.

### CROSS-REFERENCE TO RELATED APPLICATIONS

The present patent application claims priority to the previously filed and copending provisional patent application entitled “Variations of a dynamically self-stabilizing elastic keyswitch” filed on Mar. 18, 2010, and assigned application No. 61/340,522. The present patent application is also a continuation in part of the non-provisional patent application filed on Nov. 13, 2008, and assigned publication number 20090120774, which is hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention generally relates to a keyswitch for a key of a keyboard, such as a computer keyboard like a laptop computer keyboard, and more specifically relates to such an ultra-thin keyswitch that is dynamically self-stabilizing and elastic that allows for very thin keyboards.

Laptop computers, which are also referred to as notebook computers, include integrated keyboards and integrated displays. As such, a laptop computer is a single computing device that permits a user to input information via the integrated keyboard and to receive information via the integrated display. A design goal with many types of laptop computers has been to decrease their dimensional size, such as the thickness of such laptop computers.

One part of decreasing the thickness of a laptop computer is to employ a relatively thin integrated keyboard. However, it is still desirable to maintain a relatively high key travel, which is the distance that a given key physically moves perpendicular to the keyboard when depressed by a user. Relatively high key travel permits a laptop computer keyboard to mimic the tactile feel of a standalone computer keyboard commonly attached to desktop computers.

A difficulty with maintaining relatively high key travel of relatively thin laptop computer keyboards is that the keys are prone to wobble or tilt. Wobble and tilt are undesirable, as they qualitatively degrade the user experience of typing on the keyboard. As such, users are not as likely to enjoy typing on the keyboard, and the users are likely to not be able to type as quickly on the keyboard as compared to standalone computer keyboards.

One way to minimize wobble and tilt is to employ a rigid scissor-type keyswitch arrangement, which permits balanced key travel during key presses. However, scissor keyswitches are typically manufactured using a number of separate pieces via expensive injection-molding techniques, and thereafter require complex assembly. As such, scissor keyswitches are not amenable to inclusion within relatively inexpensive laptop computers, where the cost of their keyswitches is prohibitive.

Additionally, scissor-type keyswitches are rigid and add an extra thickness requirement to the keyboard due to the need to have protruding connectors underneath the keytop to connect it to the scissor-type keyswitch. Similarly, protruding connectors are also required in the base of the keyboard to hold the scissor-type keyswitch in place on the keyboard. Again, this adds more rigidity and thickness to the keyboard.

### BRIEF SUMMARY OF THE INVENTION

The invention is a keyboard containing a number of keys that contain self-balancing keyswitches that are expandable and compressible. Each key includes a compressible-expandable elastic keyswitch, a rigid keyboard base 8, a mechanical actuator switch 6, and a printed circuit board 7.

Each compressible-expandable elastic keyswitch includes a rigid keytop 1, one or more thin elastic membranes 2, and a compressible-expandable spherical surface 4. The thin elastic membrane 2 in conjunction with the compressible-expandable spherical surface 4 act as a self-stabilizing and balancing mechanism to prevent key wobble and tilting during a key press similar to the functionality provided by the scissor-type keyswitch in prior art. Furthermore, the properties of the compressible-expandable spherical surface 4 is what allows the compressible-expandable elastic keyswitch, and thereby the keyboard and keys, to compress and or expand.

In its expanded state, the properties of the compressible-expandable spherical surface 4 may be that of a hollow sphere filled with air pressure having an external surface composed of a very thin and slightly elastic yet firm membrane. Alternatively, the compressible-expandable spherical surface 4 may be composed of a thin spherical spring or flat spring that may take on a spherical or circular shape. In order to compress the compressible-expandable spherical surface 4, its air may be removed via an air inlet-outlet hole 5 and or its spring compressed via an external force such that it becomes totally flat and thin. This is advantageous over prior art that uses scissor-type keyswitches as it allows for the keyboard to be very thin and flexible.

### BRIEF DESCRIPTION OF THE SEVERAL VIEWS OF THE DRAWING

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a cross-sectional side view of a compressible-expandable elastic keyswitch in its expanded state, a rigid perimeter 3, a rigid keyboard base 8, a mechanical actuator switch 6, and a printed circuit board 7, as part of a single key of a computer keyboard, according to an embodiment of the invention. The compressible-expandable elastic keyswitch is composed of a rigid keytop 1, a thin elastic membrane 2, a compressible-expandable spherical surface top 4A and compressible-expandable spherical surface bottom 4B, collectively referred to as the compressible-expandable spherical surface 4, and air inlet-outlet opening 5.

FIG. 2 is a diagram of a cross-sectional side view of a compressible-expandable elastic keyswitch in its compressed state, a rigid perimeter 3, a rigid keyboard base 8, a mechanical actuator switch 6, and a printed circuit board 7, as part of a single key of a computer keyboard, according to an embodiment of the invention. The compressible-expandable elastic keyswitch is composed of a rigid keytop 1, a thin elastic membrane 2, a compressible-expandable spherical surface top 4A and compressible-expandable spherical surface bottom 4B, collectively referred to as the compressible-expandable spherical surface 4, and air inlet-outlet opening 5.

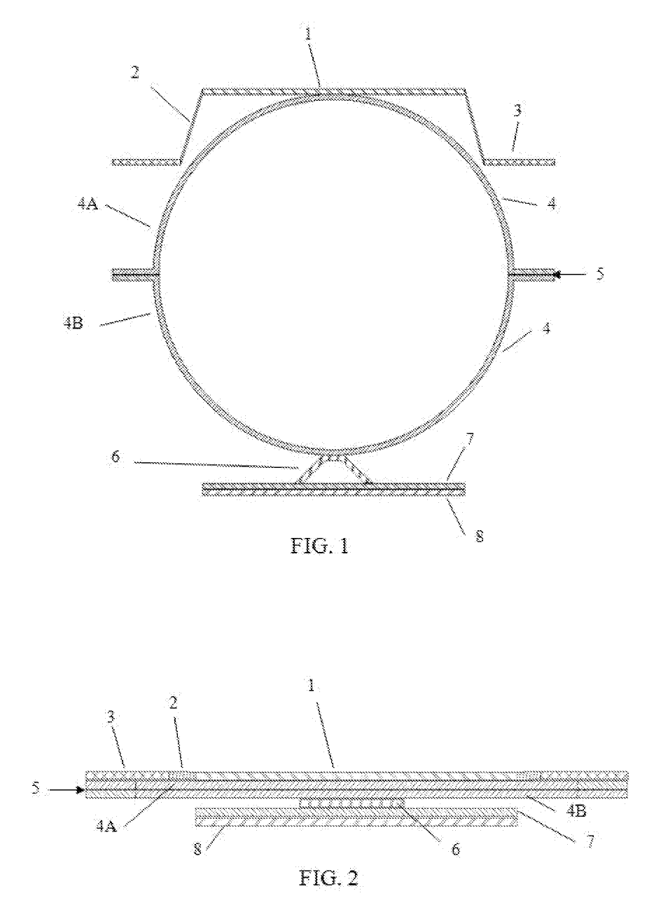

### DETAILED DESCRIPTION OF THE INVENTION

A keyboard of an embodiment of the invention includes an expandable and compressible keyboard containing a number of keys that are likewise expandable and compressible. Each expandable and compressible key includes a compressible-expandable elastic keyswitch, a rigid keyboard base 8, a mechanical actuator switch 6, and a printed circuit board 7.

Each compressible-expandable elastic keyswitch includes a rigid keytop 1, one or more thin elastic membranes 2, and a compressible-expandable spherical surface 4. The properties of the compressible-expandable spherical surface 4 is what allows the compressible-expandable elastic keyswitch, and thereby the keyboard and keys, to compress and or expand.

The rigid keytop 1 has a central axis at least substantially perpendicular to a surface of the rigid keytop 1. The thin elastic membrane 2 is disposed relative to the central axis, which is at least substantially perpendicular to a surface of the thin elastic membrane 2. The compressible-expandable spherical surface 4 is disposed below the rigid keytop 1 and relative to the central axis, which is at least substantially perpendicular to a surface of the compressible-expandable spherical surface 4.

The rigid keytop 1 is disposed above the compressible-expandable spherical surface 4. The mechanical actuator switch 6 is disposed between the compressible-expandable spherical surface 4 and the rigid keyboard base 8. The printed circuit board 7 is disposed between the rigid keyboard base 8 and the mechanical actuator switch 6. The printed circuit board 7 registers actuation of the key in question, responsive to the mechanical actuator switch 6 coming into contact with the printed circuit board 7. Alternatively, a pressure sensor may be incorporated into the mechanical actuator switch 6 to register a key press, thereby potentially negating the need for a printed circuit board 7 in such embodiment.

The keyboard has a rigid perimeter 3 about each key. For each compressible-expandable elastic keyswitch, the outer perimeter of its thin elastic membrane 2 is attached about this rigid perimeter. When the compressible-expandable elastic keyswitch is in its compressed state, the thin elastic membrane 2 is disposed about the perimeter of the rigid keytop 1 in the same plane such that the rigid keytop 1 concentrically sets within the thin elastic membrane 2. When the compressible-expandable elastic keyswitch is in its expanded state, the thin elastic membrane 2 is stretched such that its outer endpoints attached to the rigid perimeter are disposed at a distance below its inner endpoints which are attached to the outer perimeter of the rigid keytop 1. The distance in height between the outer (lower) and inner (upper) endpoints of the thin elastic membrane 2 is roughly equal to the key travel distance. This disposition of the thin elastic membrane 2 below the rigid keytop 1 creates a slight tension of distributed forces about the perimeter of the rigid keytop 1 and thereby the surface of the compressible-expandable spherical surface 4. These distributed forces within the stretched thin elastic membrane 2 act as a self-stabilizing and balancing mechanism that act to pull all edges of the rigid keytop 1 down simultaneously during a key press much as the different rigid members of the scissor-type keyswitch pull the opposing sides of a keytop down during a key press.

It should be noted by those skilled in the art that the invention has been described with reference to a number of embodiments. The number, materials, operating mechanisms, properties, sizes, shapes, types, and other characteristics of the components that are not depicted or described are trivial and numerous variations of these exist which may be used to construct the device without changing the spirit and scope of the invention. As such, it is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. Therefore, it is manifestly intended that this invention be limited only by the claims and equivalents thereof.

What I claim as my invention is:

1. An elastic keyswitch for use in a key of a keyboard comprised of one or more of a thin elastic membrane having one or more of perimeter endpoints attached to one or more of a rigid perimeter, the thin elastic membrane having a surface disposed one or more of about the perimeter and below the surface of a rigid keytop, the rigid keytop being disposed one or more of above a point and attached at a point and above a cross section of the top surface of a spherical surface and attached to a cross section of the top surface of a spherical surface, the spherical surface being disposed above a mechanical actuator switch, the mechanical actuator switch being disposed one or more of above a printed circuit board and rigid base.

2. The elastic keyswitch of claim 1, wherein the spherical surface is comprised of a thin membrane filled with air having inlet and outlet openings that attach to an on-off air valve, the on-off air valve being attached to an air pump that one or more of pumps air into and out of the thin membrane.

3. The elastic keyswitch of claim 2, wherein the spherical surface is compressed to a thin flat surface by removing air from the thin membrane via the inlet and outlet openings.

4. The elastic keyswitch of claim 3, wherein the thin flat surface is expanded to a spherical surface by pumping air into the thin membrane via the inlet and outlet openings.

5. The elastic keyswitch of claim 4, wherein the resultant rigid keytop and top part of the spherical surface is located in a plane above the rigid perimeter such that tension is created in the thin elastic membrane.

6. The elastic keyswitch of claim 5, wherein the tension in the thin elastic membrane creates distributed forces that act to prevent key wobble and tilting by dynamically stabilizing the spherical surface by reducing the rotational tendency about the mechanical actuator switch and thereby balancing the rigid keytop when an external force is applied to the rigid keytop.

7. The elastic keyswitch of claim 1, wherein the spherical surface is comprised of one or more of a spherical spring and flat spring and spring and foam.

8. The elastic keyswitch of claim 7, wherein the spherical surface is compressed to a thin flat surface by one or more of removal of an external force and the application of an external force.

9. The elastic keyswitch of claim 8, wherein the thin flat surface is expanded to a spherical surface by one or more of removal of an external force and the application of an external force.

10. The elastic keyswitch of claim 9, wherein the resultant rigid keytop and top part of the spherical surface is located in a plane above the rigid perimeter such that tension is created in the thin elastic membrane.

11. The elastic keyswitch of claim 10, wherein the tension in the thin elastic membrane creates distributed forces that act to prevent key wobble and tilting by dynamically stabilizing the spherical surface by reducing the rotational tendency about the mechanical actuator switch and thereby balancing the rigid keytop when an external force is applied to the rigid keytop.
